(19) United States
(12) Patent Application Publication
(10) Pub. No.: US 2020/0000220 A1
(43) Pub. Date: Jan. 2, 2020

(54) ELECTRONIC CLASSROOM DESKS

(71) Applicant: HEWLETT-PACKARD DEVELOPMENT COMPANY, L.P., Spring, TX (US)

(72) Inventors: Ligy Kurian, Spring, TX (US); Yolanda Rivas, Spring, TX (US)

(73) Assignee: HEWLETT-PACKARD DEVELOPMENT COMPANY, L.P., Spring, TX (US)

(21) Appl. No.: 16/484,190

(22) PCT Filed: Feb. 9, 2017
(86) PCT No.: PCT/US2017/017097

§ 371 Date: Aug. 7, 2019

(51) Int. Cl. A47B 41/02; A47B 21/007; G09B 5/06; H04L 29/08; G06Q 50/20

(52) U.S. Cl. CPC A47B 41/02; A47B 21/007; G09B 5/06; A47B 2021/066; G06Q 50/2053; A47B 2021/0076; H04L 67/125

(57) ABSTRACT

In some examples, an electronic classroom desk includes a desktop comprising a display device, and a processor to authenticate a student at the electronic classroom desk based on received authentication information of the student, and responsive to authenticating the student: cause display, on the display device, of class material selected based on a criterion relating to which class the student is currently attending, and cause display, on the display device, of student-specific information that corresponds individually to the student, without regard to the criterion.

### BACKGROUND

A classroom allows a presenter to present to audience members who are there to learn about a subject being presented by the presenter. The presenter can be referred to as a teacher, and the audience members can be referred to as students.

### BRIEF DESCRIPTION OF THE DRAWINGS

Some implementations of the present disclosure are described with respect to the following figures.

FIG. 1 is a perspective view of an electronic classroom desk according to some examples.

FIG. 2 is a flow diagram of a process of an electronic classroom desk according to some examples.

FIG. 3 is a block diagram of an electronic classroom desk according to some examples.

FIGS. 4A and 4B show different positions of a retractable keyboard in an electronic classroom desk according to further examples.

FIG. 5 is a block diagram of a storage medium storing machine-readable instructions according to some examples.

FIGS. 6 and 7 are block diagrams of electronic classroom desks according to various examples.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A classroom can refer to an environment that includes a physical room (or multiple physical rooms) in which audience members are located to consume information presented by a presenter (or multiple presenters). A presenter in a classroom can be referred to as a teacher, and the audience members in the classroom can be referred to as students. A classroom can exist in an educational setting, such as in a grade school setting (elementary school, middle school, high school), a university or college setting, a trade school setting, or any other setting in which audience members are to learn from information presented by a presenter (or multiple presenters). In some cases, a classroom can include multiple locations that are geographically dispersed, where the teacher is at a first site and students can be at multiple different sites, and the presentation made by the teacher can be communicated to students over a network.

Students attending a classroom may bring physical textbooks and possibly personal electronic devices, such as notebook computers, tablet computers, smartphones, and so forth. Students can work on class assignments on their personal electronic devices, or on paper. Physical textbooks and personal electronic devices can be heavy, and may be difficult for students to carry from class to class. Also, students may write or enter class notes and school assignments on pieces of paper or in their personal electronic devices. Such class notes and school assignments may be easily lost or may be difficult to find or retrieve.

Additionally, a teacher may have to spend some amount of time at the beginning of each class taking attendance, which can take away from teaching time, or time spent on exams or class assignments. Additionally, to make announcements or to send notifications to students, a teacher may have to write the announcements or notifications on pieces of paper that are handed out to students, or send emails to students, which may be missed by students in class.

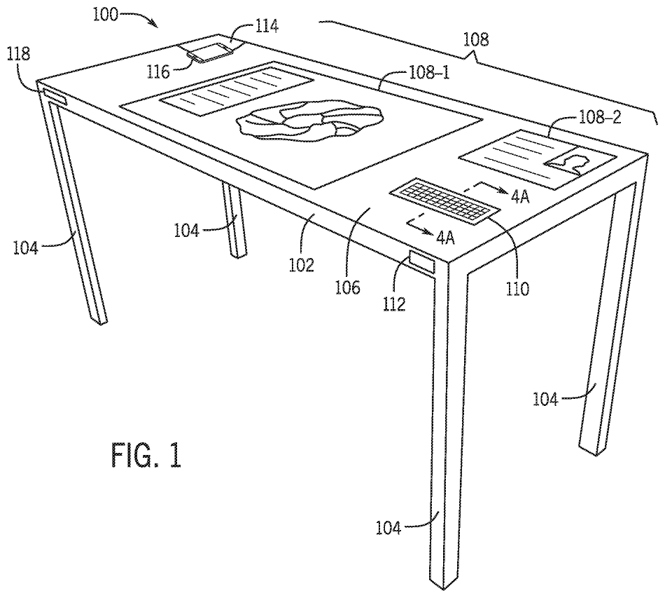

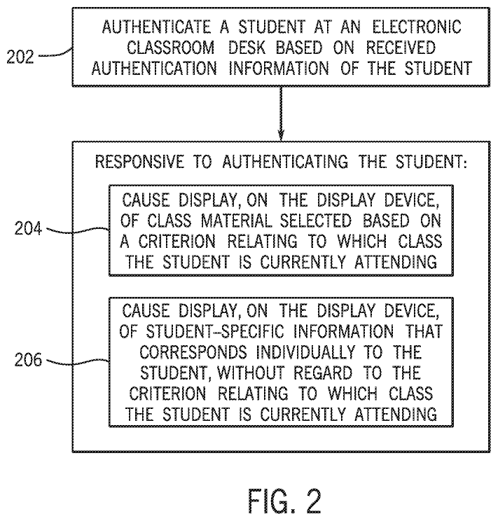

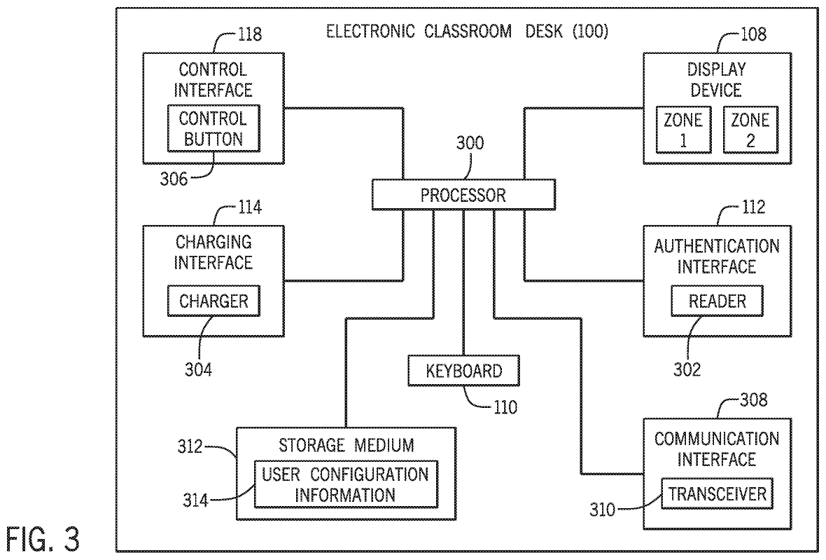

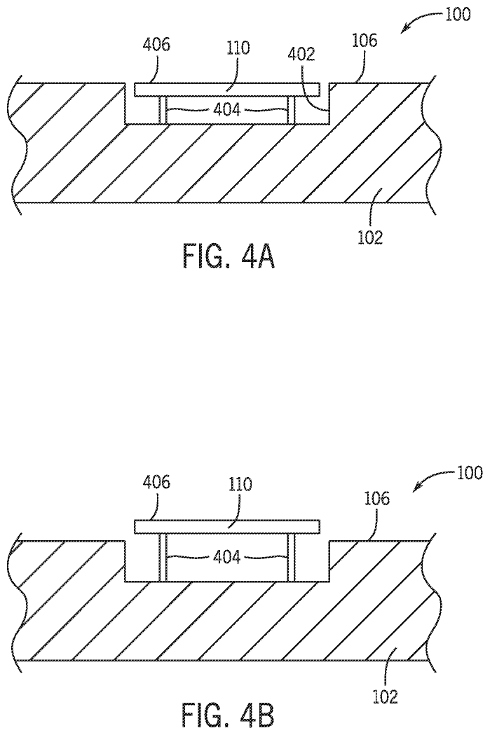

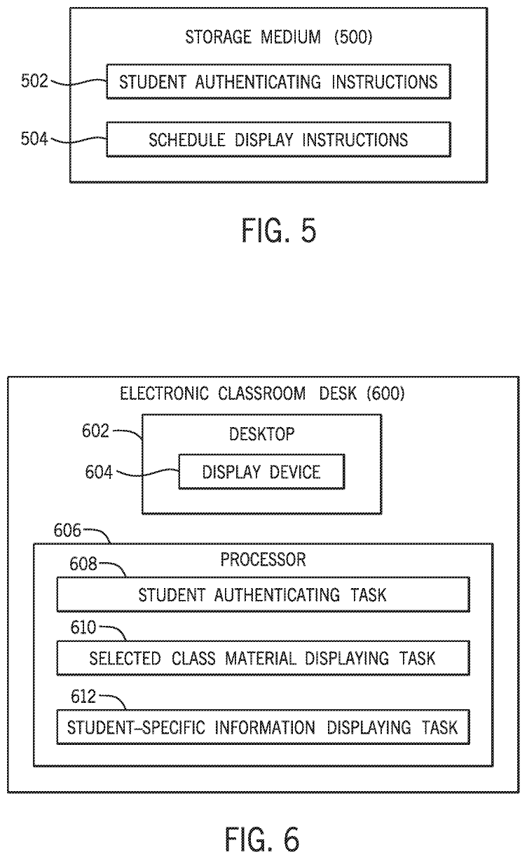

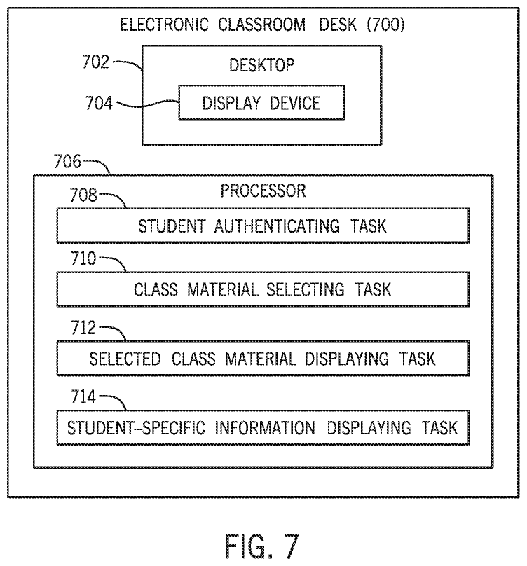

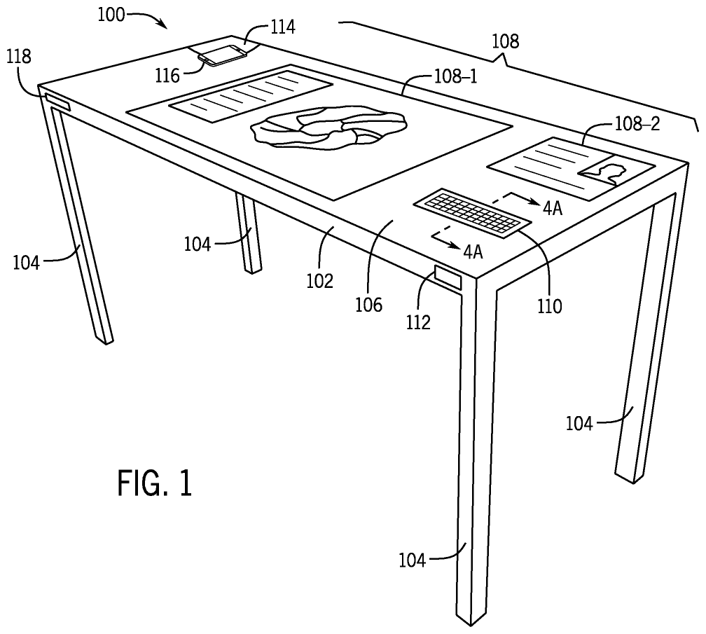

In accordance with some implementations of the present disclosure, electronic classroom desks can be provided in classrooms for use by students. FIG. 1 shows an example electronic classroom desk 100, which includes a desktop 102 supported by support stands 104. For example, FIG. 1 shows the electronic classroom desk in the form of a table, where the desktop 102 is a table top and the support stands 104 are legs. In other examples, the electronic classroom desk can be in the form of a desk with drawers (not shown).

The desktop 102 has an upper surface 106 on which a student (or multiple students) can place physical items, and on which the student(s) can work.

The electronic classroom desk 100 includes a display device 108 provided on the desktop 102. More specifically, the display device 108 has a display area that is visible above the upper surface 106 of the desktop 102. In examples according to FIG. 1, the display device 108 includes a first display panel 108-1 and a second display panel 108-2, where the different display panels 108-1 and 108-2 can be used to present respective different information. For example, the display panel 108-1 can be considered a first display zone of the display device 108, where this first display zone can be used to display class material, i.e., material that is relevant for a specific class. The display panel 108-2 can be considered a second display zone, separate from the first display zone in the display device 108, where student-specific information that corresponds individually to the student can be displayed.

Although FIG. 1 shows the display device 108 implemented with multiple display panels 108-1 and 108-2, it is noted in other examples, the display device 108 can be a larger display panel that extends across a wider portion of the upper surface 106 of the desktop 102. Such a larger display panel can be divided into multiple display zones to display respective different information. Moreover, in further examples, the display device 108 can be implemented with more than two display panels to provide additional display zones.

In some examples, one or both of the display panels 108-1 and 108-2 can be touch-sensitive display panels, where a student can use his or her fingers or a stylus to make touch inputs on the display panel 108-1 or 108-2.

More generally, the display device 108 of the electronic classroom desk 100 can be used to flexibly and selectively display relevant information to a student.

In some examples, the display device 108 can initially display links, such as in a browser window or a window of another application program, where the displayed links are selectable by a student to navigate to various information, including selected class materials (e.g., an online textbook, a teacher's website, notes prepared by a teacher, a quiz or test prepared by the teacher) and/or other resources. The selected class materials or other resources that are accessible by a student based on selection of the displayed links can be controlled by a teacher or by an administrator, in some examples. Moreover, additional links can be displayed by the display device 108 to allow the student to navigate to student-specific information (discussed further below).

The display device 108 can also display icons (or other representations) representing application programs that can be opened by the student. The application programs can include a word processing application, a spreadsheet application, an email application, an application used to perform an assignment or to take an exam or quiz, and so forth. In some examples, the second display zone that displays student-specific information can be used to display icons of applications that a student is able to access and select for execution. As an example, a teacher or administrator can restrict which applications are accessible by a given student, and the icons of just those applications can be displayed in the second zone (applications for which icons are not displayed in the second display zone may not be accessible by the given student). As a further specific example, a first teacher may allow the given student to access a directory application to access a student directory during the first teacher's class, while a second teacher may not allow the given student to access the directory application.

In further examples, a teacher may also be given the ability to control, either manually or automatically, what is displayed in the second display zone. For example, when the given student is taking a quiz or test, the second display zone may be manually or automatically turned off to prevent cheating based on access of materials that the student should not be accessing during the quiz or test (e.g., the desk may automatically detect when the student is taking a test). Additionally, in other examples, a teacher may also control what is seen in the first display zone but not in the second display zone, or the teacher may control what is seen in both the first and second display zones.

Additionally, the display device 108 can allow a student to browse to websites, such as to perform research.

In some examples, the electronic classroom desk 100 can include a keyboard 110, which can be used to enter information to the display device 108. As explained further below, the keyboard 110 can be a retractable keyboard, which can be raised above the upper surface 106 of the desktop 102 for use, and can be retracted below the upper surface 106 of the desktop 102 when not in use. Although not shown, the electronic classroom desk 100 can also include another user input device, such as a digital pen or a stylus, which can be used by the student to enter information into the electronic classroom desk 100, in addition to using touch inputs on a touch-sensitive display device.

Moreover, the electronic classroom desk 100 can be used to authenticate students based on authentication information received from the students. For example, a student may be assigned an electronic badge, which can be in the form of an identifier (ID) card that includes an electronic chip. The electronic chip in the electronic badge can be used to communicate with an authentication interface 112 on the electronic classroom desk 100. The authentication interface 112 can include a communication transceiver to communicate wirelessly with the electronic badge. For example, the wireless communication between the wireless transceiver of the authentication interface 112 and a wireless transceiver of the electronic badge can include radio-frequency identification (RFID) communication, a near-field communication (NFC), an infrared communication, or any other type of wireless communication.

In further examples, instead of using a wireless transceiver to perform wireless communication for authentication purposes, the authentication interface 112 can include a physical slot to physically receive a student's badge. In such examples, the badge can include a magnetic strip that encodes authentication information that can be read by the authentication interface 112 when the badge is physically inserted into the slot of the authentication interface 112. Alternatively, the badge can include printed information that can be read by an optical reader of the authentication interface 112 to authenticate a student.

In yet other examples, the authentication interface 112 can include a biometric reader to sense a biometric characteristic of a student, such as the student's fingerprint, the student's iris, the student's voice, and so forth, to authenticate the student.

In further examples, the student can perform authentication with the electronic classroom desk 100 by entering the student's user identifier or username and a passcode, such as a password, personal identification number (PIN), and so forth, into the electronic classroom desk 100, such as by using a touch-sensitive display device 108 or by using the keyboard 110 or another user input device.

In additional examples, authentication of a student can be based on the received authentication information as well as based on a current class period and a seat assignment of students in the current class. The electronic classroom desk 100 can be provided information regarding which student is assigned the particular electronic classroom desk 100 during a specific class. The electronic classroom desk 100 can also be provided with information of seat assignments of students in the specific class. Based on the current time period and the seat assignment of students, the electronic classroom desk 100 can expect that a particular student is to be present at the electronic classroom desk 100, and can look for authentication information for the particular student. The electronic classroom desk 100 would not authenticate another student for a given class period.

The electronic classroom desk 100 can log the student into the electronic classroom desk 100 in response to authenticating the student. After some specified time interval of inactivity, the processor 300 can automatically log out the student from the electronic classroom desk 100. When the student is logged out from the electronic classroom desk 100, various features of the electronic classroom desk 100 can be disabled, including the display device 108, for example.

In some examples, the electronic classroom desk 100 can also include a charging interface 114, which can be used to charge an electronic device of a student. In some examples, the charging interface 112 can include a wireless charging interface, where charging of the electronic device 116 can be based on wireless coupling (e.g., inductive or resonance coupling) between a power charger of a charging interface 114 and the electronic device 116. Examples of the electronic device 116 can include a handheld device (e.g., a smartphone, a tablet computer), a notebook computer, a wearable device (e.g., a smart watch, smart eyeglasses, a head-mounted device, etc.), or any other type of electronic device. In further examples, in addition to using wireless coupling to perform power charging, the electronic classroom desk 100 can also be provided with a power outlet (or multiple power outlets) to allow for the electronic device 116 to be plugged in using a power cable to perform charging of the electronic device 116.

In examples according to FIG. 1, the charging interface 114 is provided on the upper surface 106 of the desktop 102, such that the electronic device 116 can simply be placed over the charging interface 114 to perform charging. In other examples, if a power outlet is provided, then the power outlet can be located on a side of the desktop 102.

The electronic classroom desk 100 can also include a control interface 118, which can include a control button (or multiple control buttons) which are user actuatable. For example, a control button can be an on/off button to activate or deactivate smart features of the electronic classroom desk 100. The smart features of the electronic classroom desk 100 can include the display device 108, a user input device such as the keyboard 110, the authentication interface 112, and the charging interface 114. When the on/off button is actuated to turn off the smart features, the foregoing smart features can be disabled, such that the electronic classroom desk 100 becomes a regular physical desk that provides a desktop on which a user can work. On the other hand, when the on/off button is actuated to the on position, then the smart features of the electronic classroom desk 100 are activated for use by a student (or multiple students) at the electronic classroom desk 100.

The control interface 118 can include other control buttons, such as control buttons to control a mode of the electronic classroom desk 100. The electronic classroom desk 100 can have multiple modes of operation. For example, a first mode of operation can activate a first subset of the smart features, while a second mode of operation can activate a second subset of the smart features that is different from the first subset of smart features.

In further examples, instead of using control button(s) of the control interface 118 to turn on/off smart features of the electronic classroom desk 100 or to control a mode of the electronic classroom desk 100, the touch-sensitive display device 108 can be used instead. The touch-sensitive display device 108 can display graphical control elements to control the activation/deactivation of the smart features, or to set the mode of the electronic classroom desk 100.

More generally, the electronic classroom desk 100 includes a control element that is user selectable to control the smart features of the electronic classroom desk 100. Even more generally, the smart features of the electronic classroom desk 100 can be controlled in response to a request, either from a student at the electronic classroom desk 100 or from a remote computing device.

In other examples, instead of allowing a student to activate or deactivate the smart features of the electronic classroom desk 100 or to set the mode of the electronic classroom desk 100, a teacher or an administrator can control the smart features of the electronic classroom desk 100, such as from a remote computing device. The electronic classroom desk 100 can include a communication interface to communicate over a network (a wired network or a wireless network) with the remote computing device. At the remote computing device, the teacher or administrator can issue an instruction to control the smart features of the electronic classroom desk 100 (e.g., turn on or off the smart features, or control the mode of the electronic classroom desk 100).

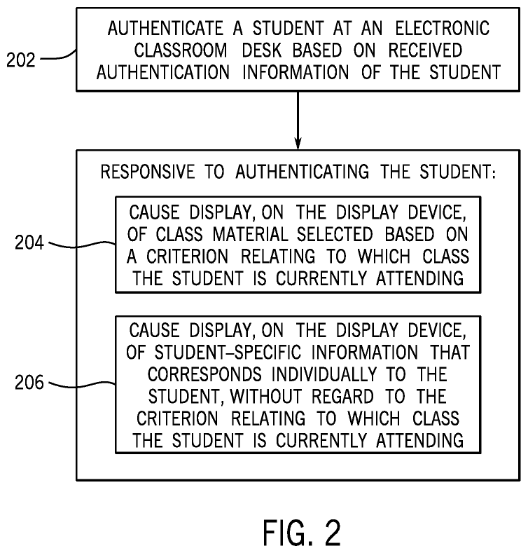

FIG. 2 is a flow diagram of an example process that can be performed by the electronic classroom desk 100 according to some examples. The electronic classroom desk 100 authenticates (at 202) a student at the electronic classroom desk 100 based on received authentication information of the student. Responsive to authenticating the student, the electronic classroom desk 100 can cause display (at 204), on the display device 108, of class material selected based on a criterion relating to which class the student is currently attending. The criterion can include a time attribute and a location attribute. The time attribute relates to a time of day, while the location attribute relates to a location of the electronic classroom desk 100. Different classrooms can be located at different locations on a campus, for example, and different classes can be held at different time periods over the course of a day in the same classroom. Thus, based on the time of day and the location of the electronic classroom desk 100, the electronic classroom desk 100 (or more specifically, a processor in the electronic classroom desk 100) can determine which class the electronic classroom desk 100 is being used for. For example, a first class in a first time period can relate to a first subject, a second class in a second time period can relate to a second subject, and so forth, where the different classes may be taught by the same teacher or by different teachers, and where different groups of students may attend the different classes. The different classes use different class materials (e.g., online books, teacher presentation materials, notes, and so forth). Thus, the class material that is selected based on the criterion relating to which class the student is currently attending is the class material that is specific to a particular class, such that class materials for other classes are not selected for display. For example, if the current time period indicates that the class is a physics class, then the material that is selected for display can include the online textbook and other materials for the physics class, as taught by a specific teacher; other materials for other classes are not selected for display by the electronic classroom desk 100.

Also, responsive to authenticating the student, the electronic classroom desk 100 causes display (at 206), on the display device 108, of student-specific information that corresponds individually to the student, without regard to the criterion relating to which class the student is currently attending. The student-specific information that corresponds individually to the student includes any information that is only relevant to the particular student, and not to other students. For example, the student-specific information can include any or some combination of the following: a schedule that includes assignments due for the student for different classes, a school announcement that is made to the student, and a reminder to the student relating to a class assignment.

The selected class material can be displayed in a first display zone of the display device 108, such as in the display panel 108-1, while the student-specific information can be displayed in a second display zone, such as the display panel 108-2.

In further examples, in addition to displaying student-specific information in the second display zone, the second display zone can also display other information, such as a school directory that includes phone numbers and/or other contact information of personnel at a school or other environment. The second display zone can be referred to as a dashboard zone that can display information other than class materials. As further examples, the dashboard zone can display management information, such as information relating to a classroom manager program that allows students to share their work, share messages, perform text messaging, and so forth. For example, the information can include displayed control elements that when activated causes sharing of the student's work with another student or with a teacher.

Since students attending a class are logged into respective electronic classroom desks (based on authentication information from the students), a program (such as the classroom manager program noted above) can automatically take attendance. Any student not logged into his or her respective electronic classroom desk by a certain time can be marked as absent or tardy automatically. As a result, a teacher does not have to waste time taking attendance.

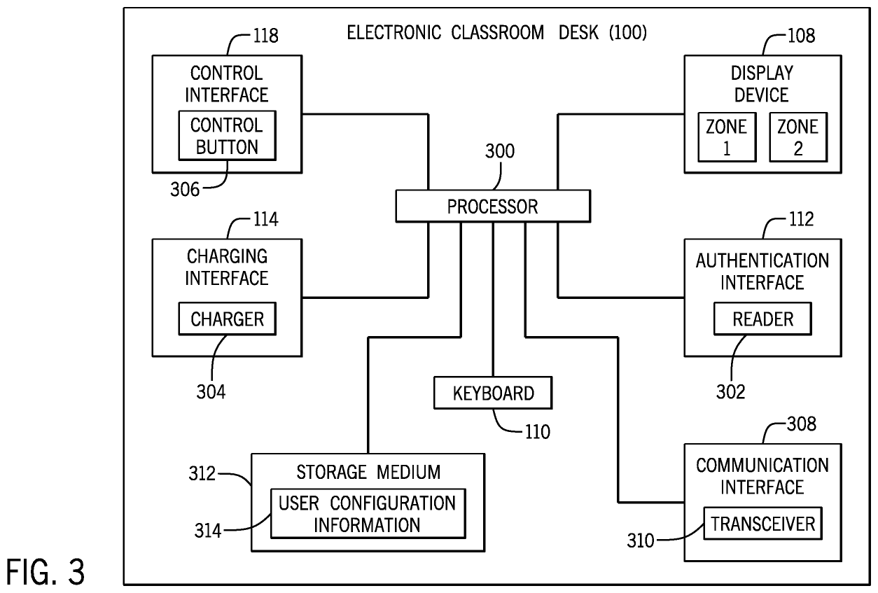

FIG. 3 is a block diagram of the electronic device 100 according to some examples. The electronic device 100 includes a processor 300, which can include any or some combination of the following: a microprocessor, a core of a multi-core microprocessor, a microcontroller, a programmable integrated circuit device, a programmable gate array, or any other hardware processing circuit. Although just one processor 300 is shown in FIG. 3, it is noted in other examples, the electronic classroom desk 100 can include multiple processors.

The processor 300 is coupled to the display device 108, to control the display of different information in the different display zones (zone 1 and zone 2 shown in FIG. 3) of the display device 108. Although FIG. 3 shows a direct connection between the processor 300 and the display device 108, it is noted that in some examples, a video controller can be provided between the processor 300 and the display device 108.

The processor 300 is also coupled to the authentication interface 112, which includes a reader 302 to receive authentication information from a student. For example, the reader 302 can include a wireless transceiver to perform wireless communication with the student's electronic badge. Alternatively, the reader 302 can include a slot to physically receive a badge, and to read information, such as magnetic information, on the badge. In other examples, the reader 302 can include a biometric reader to sense a biometric characteristic of a student. The authentication information received by the reader 302 is communicated by the authentication interface 112 to the processor 300. In other examples, as noted above, the authentication information can be input to the electronic classroom desk using a different input device, including the touch-based display device 108 or the keyboard 110.

The charging interface 114 of the electronic classroom desk 100 includes a power charger 304, which can be coupled to a power supply (not shown) of the electronic classroom desk 100. The charger 304 can be used to charge an electronic device of the student, such as by using wireless charging or wired charging. The charging interface 114 is coupled to the processor 300 to allow the processor 300 to control whether or not the charging interface 114 is active.

The control interface 118 of the electronic classroom desk 100 includes a control button 306, which can be actuated by a student, to turn on or off the smart features of the electronic classroom desk 100. When the control button 306 is actuated to the on position, the processor 300 detects this actuation and activates the smart features of the electronic classroom desk 100, such as by activating the display device 108, the authentication interface 112, the keyboard 110, and the charging interface 114. On the other hand, if the student actuates the control button 306 to the off position, then the processor 300 detects this actuation and deactivates the smart features, including the display device 108, the authentication interface 112, the keyboard 110, and the charging interface 114. Note also that the smart features can be activated or deactivated using inputs provided at the touch-based display device 108 or at the keyboard 110, or any other user input device.

In other examples, a control button of the control interface 118 can be used to set the mode of the electronic classroom desk 100 to one of multiple different modes, such as those discussed further above.

The electronic classroom desk 100 also includes a communication interface 308, which includes a transceiver 310 that is able to communicate over a network. The transceiver 310 can be a wireless transceiver to allow the communication interface 308 to communicate over a wireless network. Alternatively, or additionally, the transceiver 310 can also include a wired transceiver, to allow the communication interface 308 to communicate over a wired network.

Using the communication interface 308, the electronic classroom desk 100 can communicate with another device, such as another electronic classroom desk of another student, or with the computing device of the teacher or an administrator. The communication interface 308 can also be used to allow a student to browse to a website on the Internet.

The electronic classroom desk 100 also includes a configuration, which can include a configuration of any of the components of the electronic classroom desk 100. A configuration of a component can refer generally to an operational state of the component. For example, a configuration can specify the types of information to be displayed in the different display zones of the display device 108, whether the keyboard 110 is to be set in a retracted position or a raised position, and/or which of the smart features of the electronic classroom desk 100 are to be activated and deactivated. The configuration of the electronic classroom desk 100 can be specific to an individual student (or a group of students). Thus, the configuration of the electronic classroom desk 100 for a first student (or first group of students) can be different from the configuration of the electronic classroom desk 100 for a second student (or group of students). Moreover, a particular student may also change the configuration of the electronic classroom desk 100 at different times. For example, for a first class, the student may specify a first configuration for the electronic classroom desk 100, while for a second class, the student may specify a second configuration for the electronic classroom desk 100.

The electronic classroom desk 100 includes a storage medium 312 that stores user configuration information 314. The user configuration information 314 can be specific to an individual student, or a group of students. When the electronic classroom desk 100 is activated for use, and once a student has been authenticated, the processor 300 can retrieve the corresponding user configuration information 314 for the authenticated student, and can set the configuration of the electronic classroom desk 100 based on the retrieved user configuration information 314.

Although not shown, the storage medium 312 can also store machine-readable instructions that are executable on the processor 300 to perform various tasks. For example, the machine-readable instructions can include an operating system or an application that is able to create the first display zone for displaying class material, i.e., material that is relevant for a specific class, and the second display zone that displays the student-specific information, as discussed above. The operating system or application can define two separate windows, one for the first display zone and one for the second display zone, where different respective information is directed by the operating system or application to the respective windows. In other examples, different virtual machines can be executed in the electronic device to control the presentation of respective information in the first and second display zones. For example, a first virtual machine can generate display of the first display zone, and a second virtual machine can generate display of the second display zone. The multiple virtual machines can run respective guest operating systems and applications, and can be controlled by a virtual machine monitor in the electronic device.

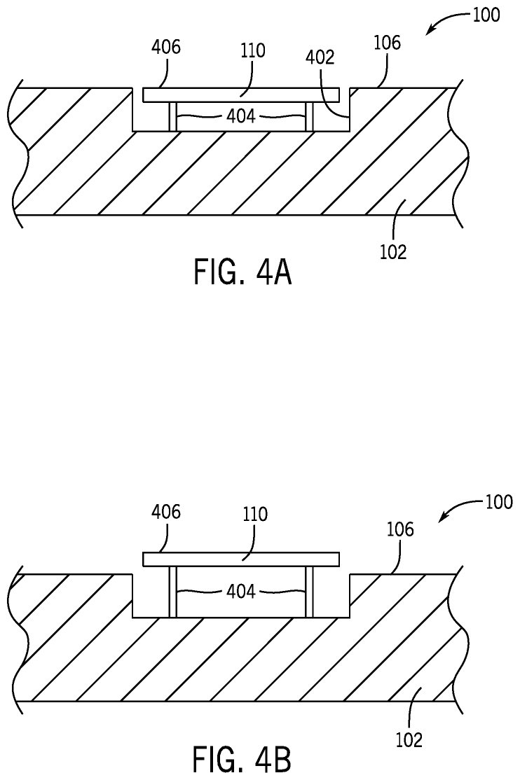

FIGS. 4A and 4B illustrate an example of different positions of the retractable keyboard 110. In the retracted position shown in FIG. 4A, the keyboard 110 is retracted into a space 402 that is below the upper surface 106 of the desktop 102. The keyboard 110 can be mounted on support members 404. In the retracted position shown in FIG. 4A, the support members 404 are retracted into the desktop 102, such that an upper surface 406 of the keyboard 110 is at or below the upper surface of the desktop 102.

FIG. 4B shows the raised position of the keyboard 110, where the upper surface 406 of the keyboard 110 rises above the upper surface 106 of the desktop 102, so that a student has easy access to the keys of the keyboard 110. To raise the keyboard 110 to the raised position, the support members 404 are raised upwardly to move the keyboard 110 upwardly.

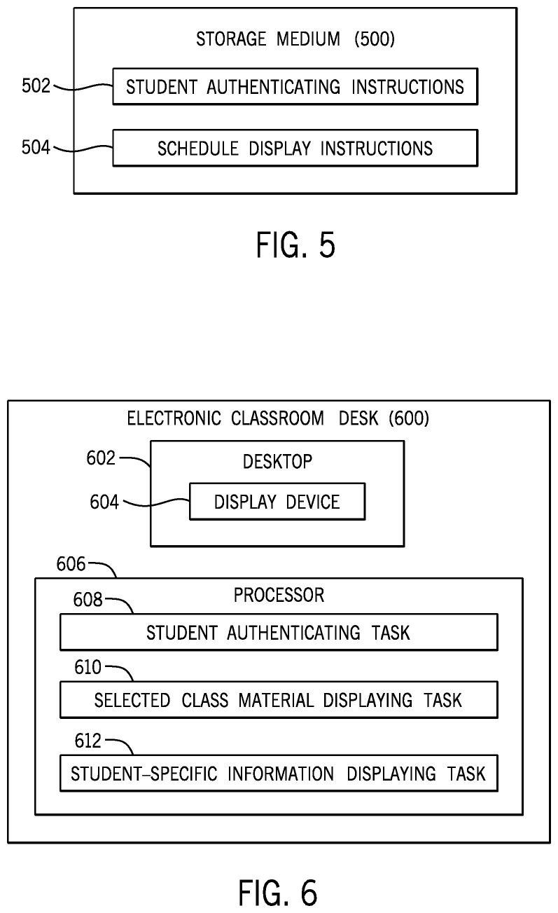

FIG. 5 is a block diagram of a non-transitory machine-readable or computer-readable storage medium 500 that stores machine-readable instructions that upon execution cause an electronic classroom desk to perform various tasks. The machine-readable instructions include student authenticating instructions 502 to authenticate a student at the electronic classroom desk based on received authentication information of the student. The machine-readable instructions further include schedule display instructions 504 that are responsive to authenticating the student to cause display, on a display device on a desktop of the electronic classroom desk, a schedule of the student, where the schedule includes school assignments due for the student at respective times.

FIG. 6 is a block diagram of an electronic classroom desk 600 according to further examples. The electronic classroom desk 600 includes a desktop 602 that includes a display device 604. The electronic classroom desk 600 further includes a processor 606 to perform various tasks. A processor perform tasks can refer to a single processor performing the tasks, or multiple processors performing the tasks. A processor can include a microprocessor, a core of a multi-core microprocessor, a microcontroller, a programmable integrated circuit, a programmable gate array, or another hardware processing circuit.

The tasks that can be performed by the processor 606 include a student authenticating task 608 to authenticate a student at the electronic classroom desk 600 based on the received authentication information of the student. In addition, the tasks performed by the processor 606 include a selected class material displaying task 610 and a student-specific information displaying task 612 that are performed in response to authenticating the student. The selected class material displaying task 610 causes display, on the display device 604, of class material selected based on a criterion relating to which class the student is currently attending. The student-specific information displaying task 612 causes display, on the display device, student-specific information that corresponds individually to the student, without regard to the criterion.

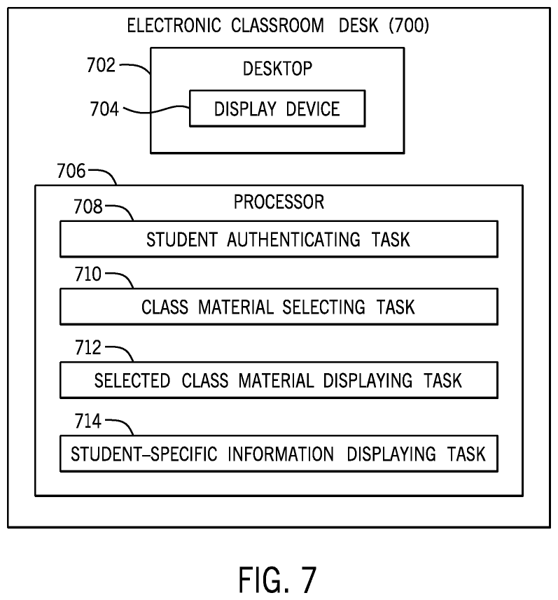

FIG. 7 is a block diagram of an electronic classroom desk 700 according to further examples. The electronic classroom desk 700 includes a desktop 702 that includes a display device 704, and a processor 706 to perform various tasks. The tasks include a student authenticating task 708 to authenticate a student at the electronic classroom desk 700 based on received authentication information of the student. The tasks further include a class material selecting task 710, a selected class material displaying task 712, and a student-specific information displaying task 714 that are performed in response to authenticating the student. The class material selecting task 710 selects from among multiple class materials for different classes, where the selecting is based on a criterion relating to which class the student is currently attending. The selected class material displaying task 712 causes display, in a first display zone in the display device 704, the selected class material. The student-specific displaying task 714 causes display, in a second display zone different from the first display zone in the display device 704, student-specific information that corresponds individually to the student without regard to the criterion.

The storage medium 500 of FIG. 5 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes, Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic classroom desk comprising:
a desktop comprising a display device; and
a processor to:
authenticate a student at the electronic classroom desk based on received authentication information of the student; and
responsive to authenticating the student:
cause display, on the display device, of class material selected based on a criterion relating to which class the student is currently attending, and
cause display, on the display device, of student-specific information that corresponds individually to the student, without regard to the criterion.

2. The electronic classroom desk of claim 1, wherein the student-specific information is selected from among:
a schedule comprising assignments due for the student for different classes,
a school announcement to the student, and
a reminder to the student relating to a class assignment,

3. The electronic classroom desk of claim 1, further comprising a charger to charge an electronic device of the student.

4. The electronic classroom desk of claim 1, wherein the student-specific information comprises representations of application programs accessible by the student.

5. The electronic classroom desk of claim 1, further comprising a keyboard in the desktop, the keyboard moveable between a raised position where a portion of the keyboard is above an upper surface of the desktop, and a retracted position where an upper surface of the keyboard is at or below the upper surface of the desktop.

6. The electronic classroom desk of claim 1, wherein the processor is to, in response to authenticating the student, retrieve stored information relating to a configuration of the electronic classroom desk for the student, and configure the electronic classroom desk for the student based on the configuration.

7. The electronic classroom desk of claim 1, wherein the processor is to authenticate the student based further on a current class period and a seat assignment of students in the current class period.

8. The electronic classroom desk of claim 1, wherein the processor is to deactivate smart features of the electronic classroom desk in response to a request, the smart features comprising displaying the class material and the student-specific information on the display device.

9. The electronic classroom desk of claim 8, wherein the request is responsive to activation of a control element that is activatable by the student.

10. The electronic classroom desk of claim 1, wherein the processor is to:
log the student into the electronic classroom desk in response to authenticating the student; and
log out the student in response to detecting a specified interval of inactivity.

11. A non-transitory machine-readable storage medium storing instructions that upon execution cause an electronic classroom desk to:
authenticate a student at the electronic classroom desk based on received authentication information of the student; and
responsive to authenticating the student, cause display, on a display device on a desktop of the electronic classroom desk, a schedule of the student, the schedule comprising school assignments due for the student at respective times.

12. The non-transitory machine-readable storage medium of claim 11, wherein the instructions upon execution cause the electronic classroom desk to:
responsive to authenticating the student, retrieve class material selected based on a criterion relating to which class the student is currently attending; and
cause display, on the display device, of the retrieved class material.

13. The non-transitory machine-readable storage medium of claim 11, wherein the authenticating of the student is based further on a current class period and a seat assignment of students in the current class period.

14. An electronic classroom desk comprising:
a desktop comprising a display device; and
a processor to:
authenticate a student at the electronic classroom desk based on received authentication information of the student; and
responsive to authenticating the student:
select class material from among a plurality of class materials for different classes, the selecting based on a criterion relating to which class the student is currently attending,
cause display, in a first display zone in the display device, the selected class material, and
cause display, in a second display zone separate from the first display zone in the display device, student-specific information that corresponds individually to the student, without regard to the criterion.

15. The electronic classroom desk of claim 14, wherein the processor is to cause display, in the second display zone, of information that allows the student to share a work of the student with another student or with a teacher.
